(19) United States
(12) Patent Application Publication
(10) Pub. No.: US 2009/0160805 A1
(43) Pub. Date: Jun. 25, 2009

(54) INFORMATION PROCESSING APPARATUS AND DISPLAY CONTROL METHOD

(75) Inventors: Daisuke HOSOKAWA, Hamura-shi (JP); Kei TOMIOKA, Tokyo (JP); Yoshinori WAKIZAKA, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/333,223

(22) Filed: Dec. 11, 2008

(30) Foreign Application Priority Data
Dec. 21, 2007 (JP) 2007-331085

(51) Int. Cl. G06F 3/041

(52) U.S. Cl. 345/173

(57) ABSTRACT

According to one embodiment, an information processing apparatus includes a display module configured to display an image including a pointer on a display screen, a detection module configured to detect a touched position on the display screen, a coordinate detection module configured to detect coordinate data of the touched position, a first pointer display module configured to display the pointer displayed on the display screen at the position detected by the detection module in an absolute coordinate input mode, an operation area display module configured to display an operation area on the display screen in a relative coordinate input mode, and a second pointer display module configured to display the pointer at a position corresponding to a displacement of a detected touched position after being moved on a surface of the display screen, if the detection module detects the touched position on the operation area.

### CROSS-REFERENCE TO RELATED APPLICATIONS

This application is based upon and claims the benefit of priority from Japanese Patent Application No. 2007-331085, filed Dec. 21, 2007, the entire contents of which are incorporated herein by reference.

### BACKGROUND OF THE INVENTION

1. Field of the Invention

The present invention relates to an information processing apparatus that can detect a position touched by the user on a display screen, and also a display control method used in the information processing apparatus.

2. Description of the Related Art

In recent years, a portable information processing apparatus such as a personal digital assistant (PDA) has come to be widely used.

Many PDAs include a display device with a touch panel, and can detect a position touched by the user with a finger or a pen on a display screen. Input of a touched position is normally carried out in an absolute coordinate system. A pointer moves to the touched position.

Jpn. Pat. Appln. Publication No. 11-095912 discloses a coordinate input apparatus. This coordinate input apparatus controls whether movement of a mouse cursor is controlled by relative coordinate data, or drawing is carried out in a drawing data display area after conversion is made to absolute coordinate data, based on a cursor coordinate position.

As described above, data for operating a pointer displayed on a display screen in the PDA is input in an absolute coordinate system. However, in order to attempt labor saving in operation, the user may desire to move a pointer by inputting data in a relative coordinate system in some cases.

In Jpn. Pat. Appln. Publication No. 11-095912 described above, a relative coordinate system is switched to an absolute coordinate system when a cursor exists in a specific window displayed on part of a large display screen. Therefore, the user can understand at a glance whether operation is carried out in the absolute coordinate system or data is manipulated in the absolute coordinate system.

However, in the PDA, one application is displayed on a display screen. Accordingly, even when a relative coordinate system and an absolute coordinate system are switched, the user cannot understand which of the coordinate systems the operation is carried out in.

### BRIEF DESCRIPTION OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view showing the appearance of an information processing apparatus according to one embodiment of the present invention;

FIG. 2 is an exemplary block diagram showing the system configuration of an information processing apparatus shown in FIG. 1;

FIG. 3 is an exemplary view showing the operation of switching from an absolute coordinate input mode to a relative coordinate input mode;

FIG. 4 is an exemplary view showing operation in the relative coordinate input mode;

FIG. 5 is an exemplary view showing the operation of switching from the relative coordinate input mode to the absolute coordinate input mode;

FIG. 6 is an exemplary block diagram showing the configuration of a pointer display control section according to one embodiment of the present invention; and

FIG. 7 is an exemplary flowchart showing the steps of processing of the pointer display control section shown in FIG. 6.

### DETAILED DESCRIPTION OF THE PREFERRED EMBODIMENT

Various embodiments according to the invention will be described hereinafter with reference to the accompanying drawings. In general, according to one embodiment of the invention, an information processing apparatus having an absolute coordinate input mode and a relative coordinate input mode, comprises a display module configured to display an image including a pointer on a display screen a detection module configured to detect a touched position on the display screen a coordinate detection module configured to detect coordinate data of the touched position a first pointer display module configured to display the pointer displayed on the display screen at the position detected by the detection module in the absolute coordinate input mode an operation area display module configured to display an operation area on the display screen in the relative coordinate input mode and a second pointer display module configured to display the pointer at a position corresponding to a displacement of a detected touched position after being moved on a surface of the display screen, if the detection module detects the touched position on the operation area.

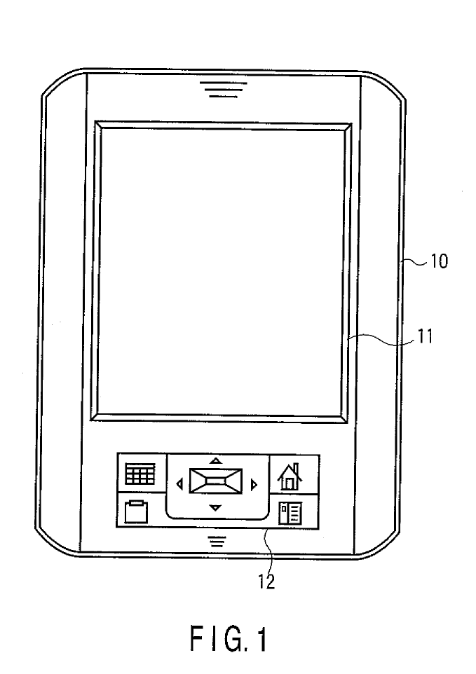

FIG. 1 shows the appearance of an information processing apparatus according to an embodiment of the present invention. This information processing apparatus is a portable information processing apparatus, and is realized, for example, as a personal digital assistant (PDA).

This PDA 10 is an information processing apparatus that supports pen input. The PDA 10 can detect a position on a display screen touched with a pen (a stylus) or a finger. The PDA 10 includes an enclosure of a thin box shape. A display device 11 and an operation key group 12 are allocated on a top surface of the enclosure. The display device 11 includes a tablet that is used for detecting a position on the display screen touched by the user. The operation key group. 12 is an input unit that is used for inputting a variety of data. The operation key group 12 includes pushbutton switches and the like. Such pushbutton switches include one used for selecting and determining a target function from a menu shown on the display device 11, and one used for starting a variety of application programs.

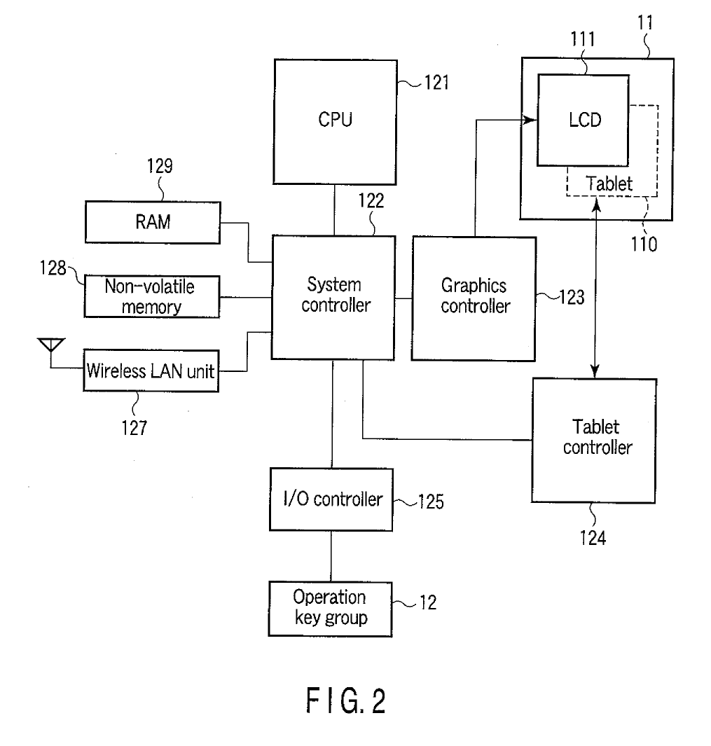

FIG. 2 is a block diagram showing the system configuration of the PDA 10. The PDA 10 includes a central processing unit (CPU) 121, a system controller 122, a graphics controller 123, a tablet controller 124, an I/O controller 125, a wireless LAN unit 127, a non-volatile memory 128, and a RAM 129, and the like, in addition to the display device 11 and the operation key group 12 described above.

The display device 11 includes a tablet 110 and a liquid crystal display (LCD) 111. The tablet 110 includes, for example, a transparent coordinate detection device allocated on a display screen of the LCD 111. As described above, the tablet 110 can detect a position (touched position) on the display screen touched by the user with a finger or a pen. The display screen of the LCD 111 functions as a so-called touch screen by operation of the tablet 110.

The CPU 121 is a processor that controls operation of the PDA 10. The CPU 121 controls each component of the PDA 10 through the system controller 122. The CPU 121 executes an operating system and a variety of application programs loaded from the non-volatile memory 128 to the RAM 129. The RAM 129 functions as a main memory of the PDA 10. The operating system supports a pen input function. Accordingly, the operating system can acquire coordinate information showing a position on the display screen of the LCD 111 touched by the user through the tablet controller 124.

The system controller 122 includes a memory controller that controls access to the non-volatile memory 128 and the RAM 129. In addition, the system controller 122 has a function for executing communication with the graphics controller 123.

The graphics controller 123 is a display controller that controls the LCD 111 that is used as a display monitor of the PDA 10. The tablet controller 124 controls the tablet 110 and acquires coordinate data showing a position on the display screen of the LCD 111 touched by the user from the tablet 110.

The I/O controller 125 controls each of the keys of the operation key group 12, and inputs an event and data corresponding to a pressed pushbutton switch in the operation key group 12. The wireless LAN unit 127 is a wireless communication device that executes wireless communication with the outside. An IP telephone is executed in a manner that the wireless LAN unit 127 connects the PDA 10 to an in-house LAN, or an external network such as the Internet.

In the present apparatus, coordinate information passed from the tablet 110 to the tablet controller 124 is represented by an absolute coordinate system with a reference position which is at a certain position on the LCD 111. When the user touches a surface of the LCD 111, an absolute coordinate of a touched position is passed from the tablet 110 to the operating system through the tablet controller 124. An absolute coordinate input mode is normally set. Accordingly, the operating system moves a pointer (operation cursor) to the passed coordinate of the absolute coordinate system.

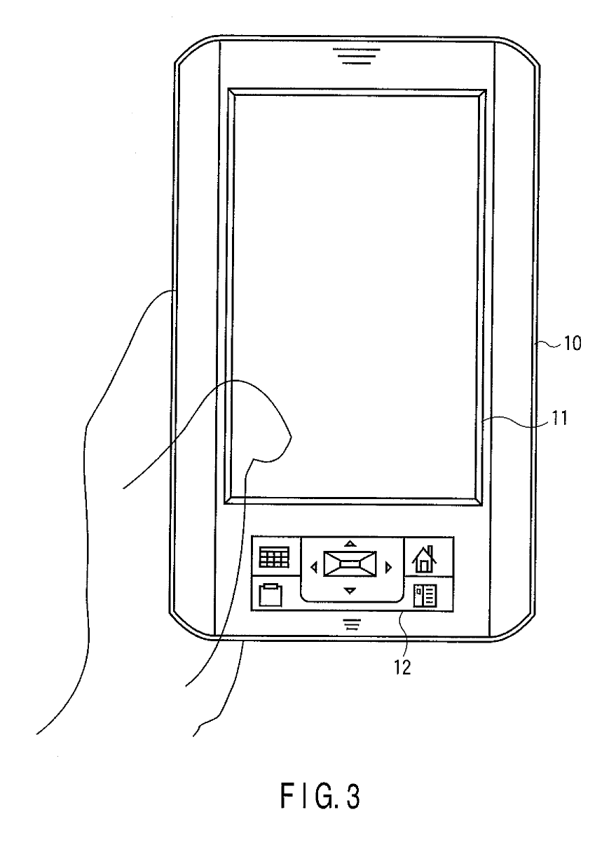

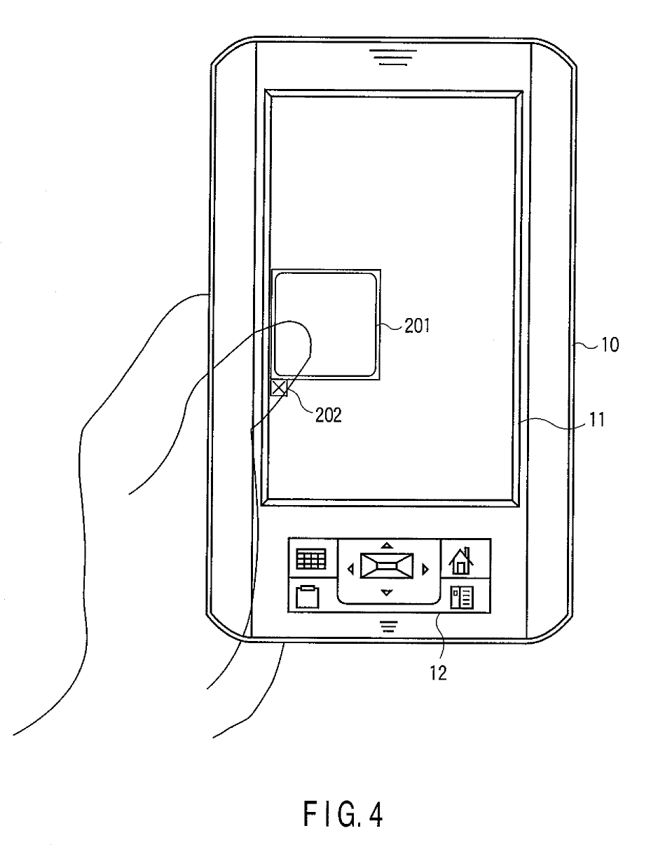

As shown in FIG. 3, when the user carries out operation in a manner flicking a surface of the LCD 111 and a pointer is released from under a finger, a translucent relative coordinate input area 201 having a substantially rectangular shape as shown in FIG. 4 is displayed at a location where the LCD 111 is flicked. In this manner, the present apparatus becomes in a relative coordinate input mode. A close button 202 is allocated in the vicinity of the relative coordinate input area 201. The close button 202 is used for returning the mode from the relative coordinate input mode to the absolute coordinate input mode.

A pattern of moving a short distance on the LCD 111 in a short period of time while pressure is reducing is recognized as flicking operation. In the present embodiment, the flicking operation is a type of pattern of touch panel basic operation, such as tapping, double tapping. Changing the mode to the relative coordinate input mode may be carried out by pressing a button and the like.

In the relative coordinate input mode, when the user carries out operation to touch the inside of the relative coordinate input area 201 with a finger and move the finger on a surface of the area, a pointer is displayed at a position corresponding to a displacement of a detected touched position. That is, in the relative coordinate input area 201, a pointer is manipulated in the relative coordinate system in a similar manner as a touch pad on a notebook personal computer.

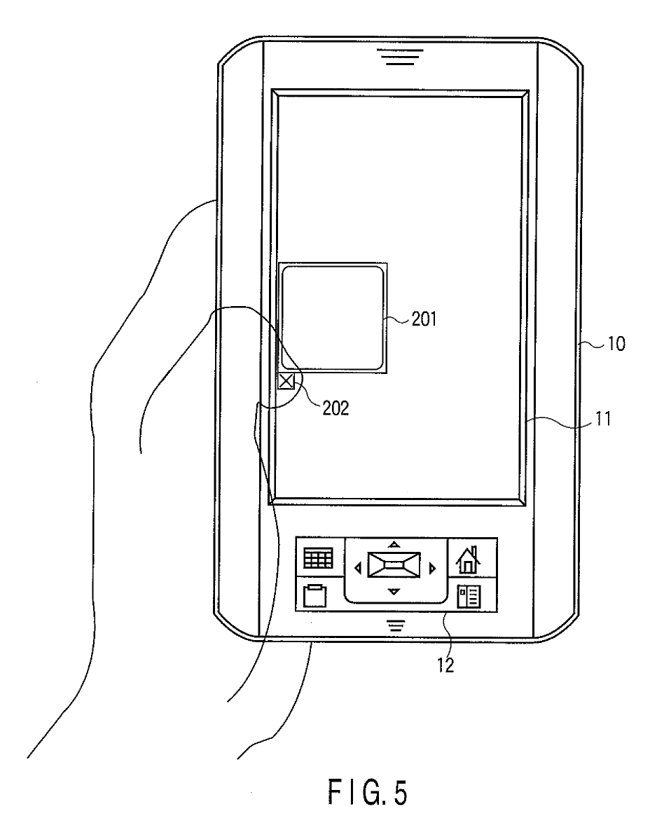

Then, as shown in FIG. 5, when the user touches the close button in the relative coordinate input area, the relative coordinate input area 201 is erased. Then, the mode is returned from the relative coordinate input mode to the absolute coordinate input mode. In this manner, as shown in FIG. 3, the present apparatus returns to a state where an entire screen is an absolute coordinate input area.

Accordingly, the relative coordinate input area 201 is displayed in the relative coordinate input mode, and the user can instinctively understand that a pointer is manipulated in the relative coordinate system. In addition, the relative coordinate input area 201 is not displayed in the absolute coordinate input mode, and the user can instinctively understand that a pointer is manipulated in the absolute coordinate system.

Next, description will be given of a pointer display control module. The pointer display control module switches the absolute coordinate input mode and the relative coordinate input mode in order to manipulate a pointer according to the input modes. The pointer display control module is software that operates in a manner resident in a system.

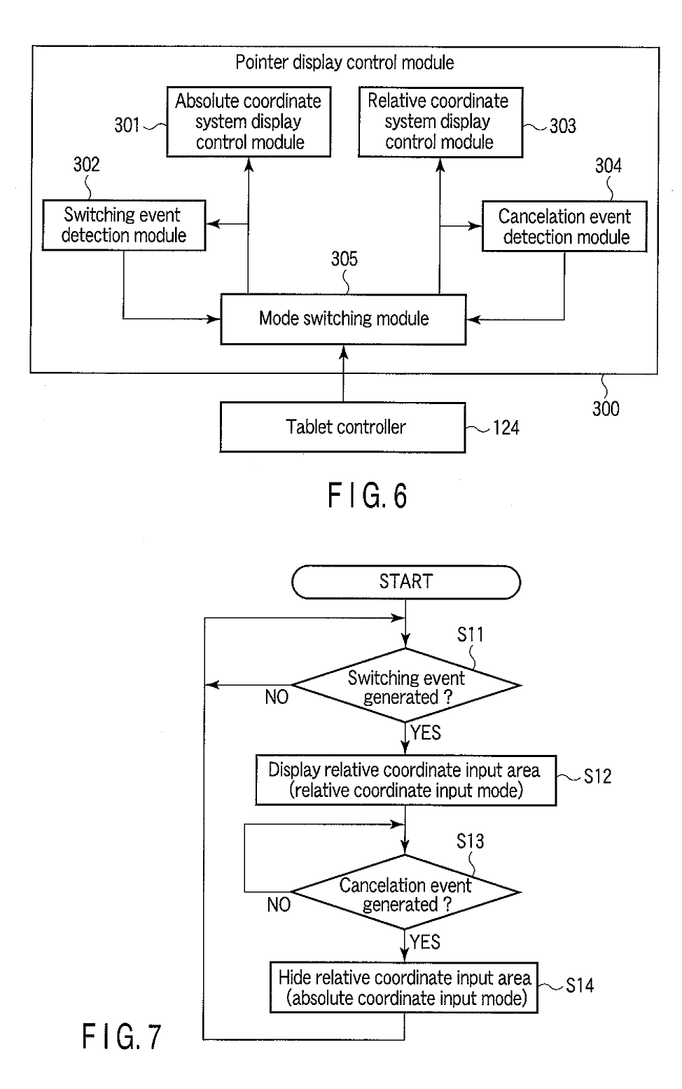

FIG. 6 is a block diagram showing the configuration of the pointer display control module 300 according to one embodiment of the present invention.

As shown in FIG. 6, the pointer display control module 300 includes an absolute coordinate system display module 301, a switching event detection module 302, a relative coordinate system display module 303, a cancelation event detection module 304, a mode switching module 305, and the like.

The switching event detection module 302 detects generation of a switching event from operation information of the tablet 110 sent from the tablet controller 124. The switching event shows that operation of flicking a surface of the LCD 111 for switching the mode from the absolute coordinate input mode to the relative coordinate input mode is carried out.

The absolute coordinate system display module 301 is a module that carries out display control of a pointer and the like in the absolute coordinate input mode. The absolute coordinate system display module 301 displays a pointer at a touched position when the user touches the LCD 111.

In addition, the absolute coordinate system display module 301 is a module that carries out display control of a pointer and the like in the relative coordinate input mode. When the relative coordinate system display module 303 detects touch in the relative coordinate input area 201, and a touched position is moved on a surface of the LCD 111, the relative coordinate system display module 303 displays a pointer at a position corresponding to a displacement of the detected touched position.

The cancelation event detection module 304 detects generation of a cancelation event showing that the close button 202 is touched from operation information of the tablet 110 sent from the tablet controller 124. The close button 202 is used for switching the mode from the relative coordinate input mode to the absolute coordinate input mode.

When the switching event detection module 302 detects the switching event, the mode switching module 305 passes display control of a pointer and the like to the relative coordinate system display module 303 in order to switch the mode from the absolute coordinate input mode to the relative coordinate input mode. In addition, when the cancelation event detection module 304 detects the cancelation event, the mode switching module 305 passes display control of a pointer and the like to the absolute coordinate system display module 301 in order to switch the mode from the relative coordinate input mode to the absolute coordinate input mode.

Next, with reference to the flowchart in FIG. 7, description will be given of the steps of processing of the pointer display control module 300.

First, the switching event detection module 302 monitors a mode switching event (block S11). If the switching event has not been generated, the absolute coordinate system display module 301 carries out display control of a pointer.

If the switching event is generated (YES in block S11), the switching event detection module 302 notifies generation of the switching event to the mode switching module 305. The mode switching module 305 issues a command to the relative coordinate system display module 303 to switch the mode to the relative coordinate input mode. Also, at the same time, the mode switching module 305 passes data from the tablet controller 124 to the relative coordinate system display module 303.

The relative coordinate system display module 303 displays the relative coordinate input area 201 and the close button 202 on the LCD 111 (block S12). Then, when the relative coordinate system display module 303 detects touch in the relative coordinate input area 201, and a touched position is moved on a surface of the LCD 111, the relative coordinate system display module 303 displays a pointer at a position corresponding to a displacement of the detected touched position.

After that, the cancelation event detection module 304 monitors generation of the cancelation event (block S13). If the cancelation event has not been generated, the relative coordinate system display module 303 carries out display control of a pointer.

When the cancelation event is detected (YES in block S13), the cancelation event detection module 304 notifies generation of the cancelation event to the mode switching module 305 and the relative coordinate system display module 303. The relative coordinate system display module 303 stops display of the relative coordinate input area 201 and the close button 202 (blocks S14).

The mode switching module 305 issues a command to the absolute coordinate system display module 301 to switch the mode to the absolute coordinate input mode. Also, at the same time, the mode switching module 305 passes data from the tablet controller 124 to the absolute coordinate system display module 301. After that, the absolute coordinate system display module 301 carries out display control of a pointer.

In the absolute coordinate input mode, an area for relative coordinate input is provided in a part of an area of the touch panel and input can be carried out in the relative coordinate system. Accordingly, a sense of operability with better usability can be provided, and pointing operation of the entire screen can be carried out by one hand that is holding the touch panel.

In the relative coordinate input mode as shown in FIG. 4, sections other than the relative coordinate input area 201 may function as the absolute coordinate input area, or may function in a similar manner as the Close button in the absolute coordinate input area.

According to the present apparatus, intuitive direct manipulation operation by an absolute coordinate and input with high accuracy by relative coordinate input can be used simultaneously or by being switched easily. Accordingly, the sense of operability can be improved.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus having an absolute coordinate input mode and a relative coordinate input mode, comprising;
a display configured to display an image comprising a pointer on a display screen;
a detection module configured to detect a touched position on the display screen;
a coordinate detection module configured to detect coordinate data of the touched position;
a first pointer display controller configured to display the pointer displayed on the display screen at the position detected by the detection module in the absolute coordinate input mode;
an operation area display controller configured to display an operation area on the display screen in the relative coordinate input mode; and
a second pointer display controller configured to display the pointer at a position corresponding to a change of a detected touched position by tracing a movement on a surface of the display screen, when the detection module detects the touched position on the operation area.

2. The information processing apparatus of claim 1, further comprising a mode switching module configure to change the mode to the relative coordinate input mode, when the detection module detects an operation for changing the mode from the absolute coordinate input mode to the relative coordinate input mode in the absolute coordinate input mode.

3. The information processing apparatus of claim 2, wherein
the operation for changing the mode to the relative coordinate input mode is a touch operation on the screen comprising either tapping or double tapping.

4. The information processing apparatus of claim 3, wherein the operation area display controller is configured to display the operation area at the touch operation position.

5. The information processing apparatus of claim 1, wherein the operation area display controller is configured to display a button area for changing the mode from the relative coordinate input mode to the absolute coordinate input mode in the operation area in the relative coordinate input mode.

6. A display control method of an information processing apparatus having an absolute coordinate input mode and a relative coordinate input mode, comprising:
displaying an image comprising a pointer on a display screen;
detecting a touched position on the display screen;
displaying the pointer displayed on the display screen at the detected touched position in the absolute coordinate input mode;
displaying an operation area on the display screen in the relative coordinate input mode; and
displaying the pointer at a position corresponding to a change of a detected touched position by tracing a movement on a surface of the operation area on the display screen.

7. The display control method of claim 6, comprising changing a mode to the relative coordinate input mode, when an operation for changing a mode from the absolute coordinate input mode to the relative coordinate input mode is detected in the absolute coordinate mode.

8. The display control method of claim 7, wherein
the operation for changing the mode to the relative coordinate input mode is a touch operation comprising either tapping or double tapping.

9. The display control method of claim 8, comprising displaying the operation area at the touch operation position.

10. The display control method of claim 6, wherein a button area for changing the mode from the relative coordinate input mode to the absolute coordinate input mode is displayed in the operation area in the relative coordinate input mode.
